(19) United States
(12) Patent Application Publication
(10) Pub. No.: US 2014/0358250 A1
(43) Pub. Date: Dec. 4, 2014

(54) METHOD AND DEVICE FOR THE CONTROL OF AT LEAST ONE APPLIANCE BY AT LEAST ONE OTHER APPLIANCE, APPLIANCE AND SYSTEM IMPLEMENTING SUCH A DEVICE

(71) Applicant: ARCHOS, Igny (FR)

(72) Inventors: Henri Crohas, Verrieres-Le-Buisson (FR); Raul Mallart, Paris (FR); Marc Bernard De Courville, Paris (FR); Honore Sossougah, Nanterre (FR)

(21) Appl. No.: 13/818,842

(22) PCT Filed: Sep. 7, 2012
(86) PCT No.: PCT/FR12/52008

§ 371 Date: Feb. 25, 2013

(30) Foreign Application Priority Data
Feb. 15, 2012 (FR) 1251383

(51) Int. Cl. G05B 15/02; G06F 3/041

(52) U.S. Cl. CPC G05B 15/02; G06F 3/0416; G06F 2203/04104
USPC 700/3

(57) ABSTRACT

A device for the control of at least one so-called slave appliance provided to be controlled by touch, by at least one so-called master appliance including apparatus for commanding, in particular a control pad, the device including a device for transmitting at least one command sent by action on the apparatus for commanding from the at least one master appliance to the at least one slave appliance; a processor provided for interpreting the at least one command thus transmitted and emulating a touch on the slave appliance corresponding to the at least one command.

### TECHNICAL FIELD

The present invention relates to a method and a device for the control of at least one so-called slave appliance, by at least one other so-called master appliance. It also relates to a system implementing such a control device.

The field of the invention is, non-limitatively, that of user interfaces and more particularly the field of the remote control of a touch interface using a control pad.

### STATE OF THE PRIOR ART

The context of the invention is that of touch user interfaces and that of wired or wireless remote controls.

The invention is also situated in a context where a mobile multimedia device such as a phone or a tablet computer can have significant storage capacity, processing capacity and graphics performance and can be used as a game console. Moreover, as the screen of these devices generally has small dimensions in comparison with a television screen, it is natural to wish to connect it to a screen having larger dimensions so as to benefit from improved visual comfort or to display the content to several people. To this end, these portable devices are sometimes equipped with means for connecting to a television, such as an HDMI output connection. These connections are usually, but not always, wired. The invention is also situated in the context where operating systems initially provided for use on phones or tablets are implemented in devices without a screen and intended for connection to an auxiliary screen (such as for example a TV).

Another feature of touch-screen interfaces is the necessary proximity between the screen and the user. This proximity can be defined by a maximum distance that is the length of the user's arm. A problem then arises regarding the remote control of the touch-screen device when this device is connected by a wired connection to another device, for example a television. The device must be placed close to the television and the user is at a distance, for example on a sofa.

Another context of the invention is the fact that much software has been developed with a view to being controlled by a touch interface and it is desirable to be able to run it without modification with an appliance placed at a distance from the user or with an appliance without a screen equipped with an operating system for a touch interface.

Control pads are known for controlling games consoles, remotely or not. However, the games for these consoles have been developed specifically with the aim of being controlled by these control pads, which is not the case for games developed for phones or touch-screen tablets.

A purpose of the present invention is to propose a method and a device for the control of a so-called slave appliance, by a so-called master appliance, making it possible to control a game run by the slave appliance from the master appliance even if this application was not designed to operate with the master appliance.

A purpose of the present invention is to propose a method and a device for the control of a so-called slave appliance, by a so-called master appliance, that does not require a transfer or a simulation of the user interface of the slave appliance at the level of the master appliance.

Another purpose of the present invention is to propose a method and a device for the control of a slave appliance by a master appliance, such as a control pad, that is easier and quicker to use than the current methods and devices.

Another purpose of the present invention is to propose a method and a device for the control of a slave appliance by a master appliance, such as a control pad, requiring fewer resources that the current methods and devices.

### DISCLOSURE OF THE INVENTION

At least one of the above objectives is achieved with a device for controlling at least one so-called slave appliance provided to be controlled by touch, by at least one so-called master appliance comprising means of command, in particular a control pad, said device comprising:
means for transmitting at least one command sent by action on said means of command from said at least one master appliance to said at least one slave appliance,
processing means provided for interpreting said at least one command thus transmitted and emulating a touch on the slave appliance corresponding to said at least one command.

Thus, the device according to the invention makes it possible to control a slave appliance by a master appliance without having to transfer a user interface of the slave appliance or of an application run by the slave appliance. The device according to the invention therefore makes it possible to control from the master appliance any application whatever run at the level of the slave appliance even if this application is not designed to be run or controlled by the master appliance.

Advantageously, the processing means can moreover be provided for generating an image of a touch interface on a screen connected to the slave appliance, so that an order emulated on the slave appliance activates a determined area of said screen.

The device according to the invention can moreover comprise storage means for recording a configuration of the processing means. Thus, this configuration can be saved.

Advantageously, the storage means can be situated in an Internet computer device (terminal or server). The storage means can also be incorporated in the slave appliance or also on a computer device on a local network.

The device according to the invention can moreover comprise means for loading a configuration in order to configure the processing means. Thus, the device can load a previously-saved configuration of the processing means.

In a particular version, the transmission means comprise wireless transmission and reception means.

In a particular version, the device according to the invention can moreover comprise pairing means securing a connection of said at least one master appliance and at least one slave appliance. These pairing means can make it possible to prevent an unwanted connection by a third party appliance to one and/or the other of the master and slave appliances.

Preferably, the means of command can comprise a joystick. The joystick can be a control handle.

The device according to the invention can be implemented with a slave appliance equipped with an operating system provided for functioning with a touch user interface. The slave appliance being optionally provided with a touch screen. An order emulated on the slave appliance can correspond to a tactile action (for example a touch) on a determined area of the screen.

Preferably, the means of command can comprise a button.

Advantageously, the means of command can comprise a button and the joystick and the button can cooperate with the processing means so that an action on the joystick causes a movement in the determined area of a pointer emulated on the slave appliance and an action on the button corresponds to a touch.

Moreover, the device according to the invention can be implemented with a master appliance comprising two joysticks, the processing means being capable of being arranged for interpreting and emulating several touches (“multitouch”) on the slave appliance.

Advantageously, the processing means can be arranged to emulate on the slave appliance two touches in order to carry out an action of increasing or reducing the size of an image displayed on the screen. Of course, other touches can be emulated such as scrolling or rotation. Of course, the processing means can be arranged to emulate on the slave appliance at least three touches to carry out actions such as sweeps with three or more fingers.

Moreover, the processing means can be configured to cause a command image to appear on a screen provided for displaying images generated by the slave appliance, containing one or more active areas corresponding to one or more commands emulated by the processing means.

Moreover, the active area(s) can be displayed superimposed or transparently over images being displayed on the screen connected to the slave appliance. These active areas can disappear at the end of a period of time determined by the device.

In a particular version, an active area of the screen displays a cursor, the positioning of which is linked to a position of the joystick.

According to another aspect of the invention, a method is proposed for controlling at least one so-called slave appliance provided to be controlled by touch, by at least one so-called master appliance comprising means of command, in particular a control pad, said device comprising the following steps:
transmission of at least one command sent by action on said means of command from said at least one master appliance to said at least one slave appliance,
interpretation of said at least one command thus transmitted and emulation of a touch on the slave appliance corresponding to said at least one command.

Advantageously, the interpretation of the command thus transmitted can emulate several touches (“multitouch”) on the slave appliance.

According to another aspect of the invention, an appliance is proposed, in particular a control pad, comprising means for generating commands, characterized in that it implements the method according to the invention for controlling a so-called slave appliance controlled by touch.

In a particular version, the appliance according to the invention can moreover comprise a housing for receiving the slave appliance. The appliance can, for example, comprise two side portions arranged on either side of the slave appliance. The housing can be situated between the two side portions and be arranged to be filled by the slave appliance. Thus, the master and slave appliances can appear to constitute a single appliance.

In another particular version, the master and the slave appliance can be integrated into one single appliance.

According to another aspect of the invention, a system is proposed comprising:
at least one so-called slave appliance controlled by touch,
at least one so-called master appliance, comprising means of command, and
at least one device according to the invention, provided for controlling said at least one slave appliance by said at least one master appliance.

Means for receiving the command and the processing means of the at least one command device can be incorporated in the at least one slave appliance. These means can moreover be presented in the form of modules linked to the slave appliance.

Preferably, the at least one slave appliance comprises means for running an operating system for a tablet computer or mobile phone, so that the master appliance controls a touch operating system.

The at least one slave device can comprise moreover a screen for displaying a touch user interface.

Preferably, the at least one slave device can comprise a tablet computer, a mobile phone, an interactive television or a set-top box.

### DESCRIPTION OF THE FIGURES AND EMBODIMENTS

Other advantages and features of the invention will become apparent on reading the detailed description of implementations and of an embodiment which is in no way limitative, and from the following attached drawings:

FIGS. 1A and 1B are diagrammatic representations of usual uses of an interface with a touch screen,

FIGS. 2A and 2B are diagrammatic representations of usual uses of games on an interface with a touch screen,

FIG. 3 is a diagrammatic representation of a first embodiment of a system according to the invention;

FIG. 4 is a diagrammatic representation of a second embodiment of a system according to the invention; and

FIG. 5 is a diagrammatic representation of a third embodiment of a system according to the invention;

FIG. 6 is a diagrammatic representation of a fourth embodiment of a system according to the invention;

FIG. 7 is a diagrammatic representation of a configuration of use of a system according to the invention.

FIG. 8 is a diagrammatic representation of an implementation of a first appliance according to the invention, and

FIG. 9 is a diagrammatic representation of an implementation of a second appliance according to the invention.

In the figures, the elements appearing in several figures keep the same references.

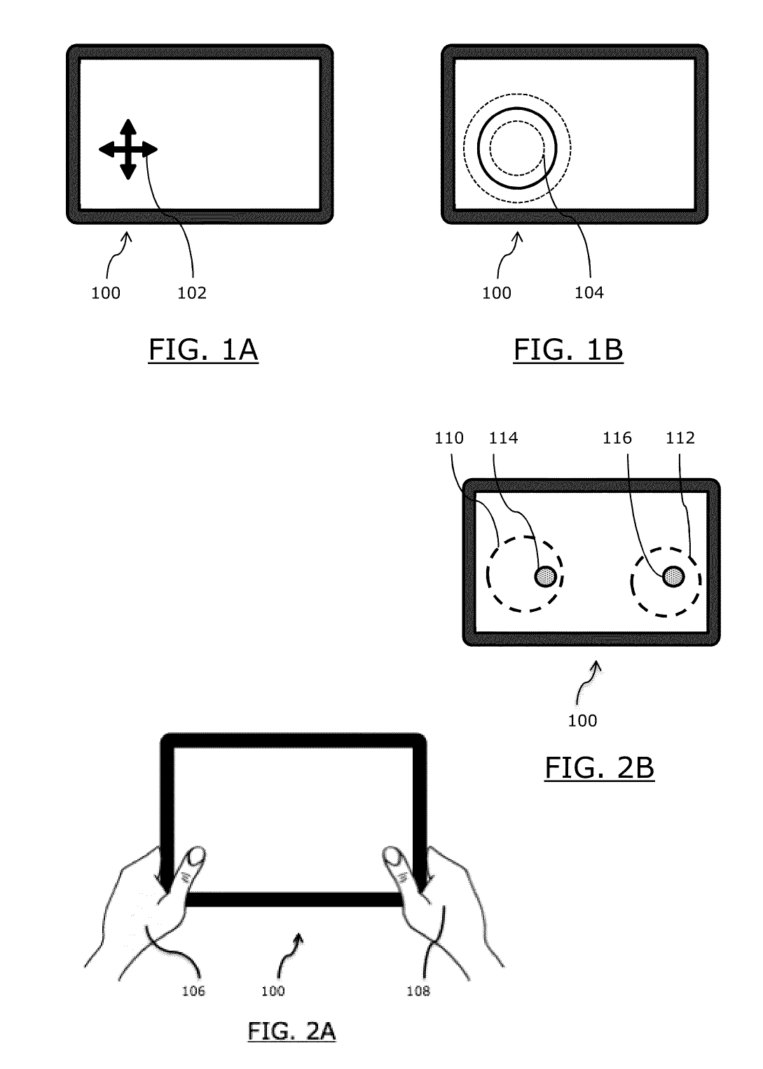

FIG. 1A shows a possible use of an interface 100 with a touch screen. The cross 102 shown in FIG. 1A shows the possibility for a user of moving the image shown in the touch interface 100. This method of moving the image (“scrolling”) has for example the advantage of being able to move the image in order to be able to display other portions. It can also for example be used for turning the pages of a book read on a tablet. This is an important function implemented in a device comprising an interface with a touch screen 100.

FIG. 1B shows another possible use of the interface 100 with a touch screen. The concentric circles 104 represented in FIG. 2B show the possibility for a user to increase the size of an image on the touch interface 100. This method of increasing the size of the image (“pinch to zoom”) has for example the advantage of allowing a user a better view of the detail of an image. This is an important function implemented in a device comprising an interface with a touch screen 100.

FIG. 2A shows the usual manner in which the interface 100 is held in the hands. A user uses his hands 106, 108 as positioned in FIG. 2A. Indeed, a significant number of applications, in particular games, require the user to make use of one or both hands on one or two surface(s) of the touch screen determined by the application or the game.

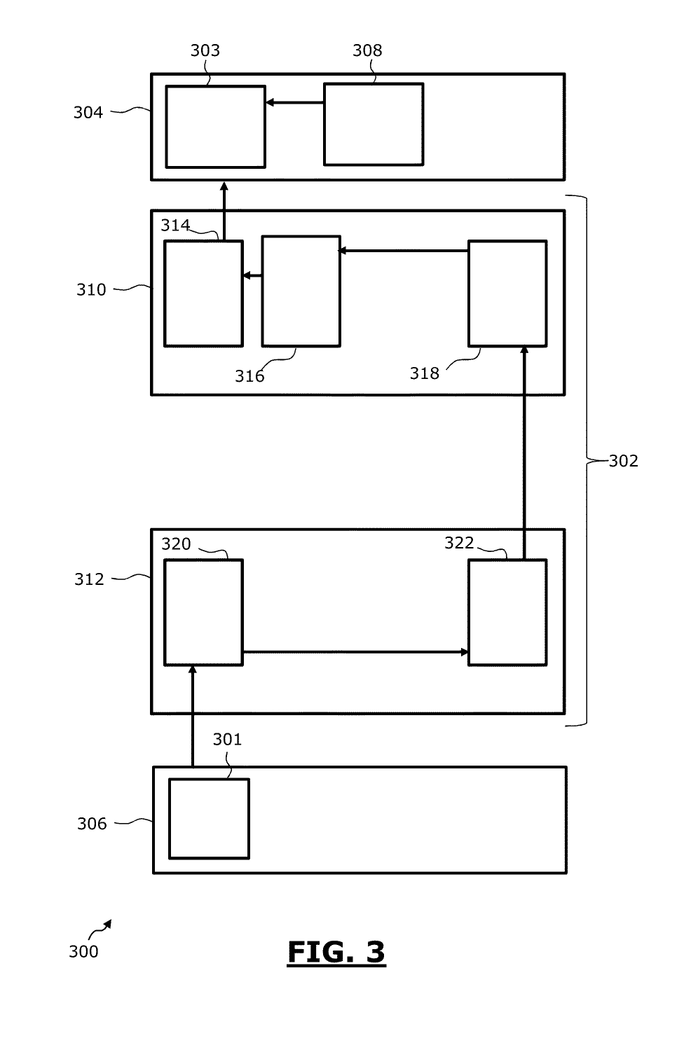

FIG. 2B shows in particular two such surfaces 110 and 112. The surface 110 is on the side of the hand 106 while the surface 112 is on the side of the hand 108. The applications or games thus define the working surfaces accessible via the user's fingers positioned at the level of the locations 114 and 116 in FIG. 3A. The surfaces 110 and 112 are adapted to the possible movements of the fingers on the touch screen and are elliptical in shape.

In a first embodiment shown in FIG. 3, the system 300 comprises a control device 302, a slave appliance 304 and a master appliance 306.

The slave appliance 304 comprises a touch interface 308 used for controlling a central processor unit 303 comprised in the slave appliance 304.

The master appliance 306 comprises commands 301 used for controlling the slave appliance 304.

The device 302, shown in FIG. 3, comprises a first so-called slave module 310, on the side of the slave appliance 304, and a second so-called master module 312, on the side of the master appliance 306.

The slave module 310 comprises:
a module 314 for communicating with the slave appliance 304, allowing data to be sent to the slave appliance 304,
a processing module 316,
a module for receiving data 318 sent by the master module 312.

The master module 312 comprises:
a module 320 for communicating with the master appliance 306, allowing data to be received from the master appliance 306,
a module for sending data 322 to the slave module 310.

When one or more actions are performed by a user on a command 301 from the master appliance 306, this action is transmitted by the master appliance 306 to the master module 312 using the communication module 320 of the master module 312.

This action is then sent to the slave module 310 via the module for sending data 322 to the slave module 310.

The slave module receives the action(s) via the module for receiving data 318 sent by the master module 312.

The action(s) are interpreted by the processing module 316 of the slave module 310 in order to determine at least one touch associated with the one or more touch command action carried out on the master appliance 312.

The at least one touch is then transmitted to the slave appliance 304 via the module for communication 314 with the slave appliance 304.

The at least one touch is then interpreted by the appliance 304 as if it originated from the touch interface 308.

Thus, the slave appliance 304 is controlled by the master appliance 306.

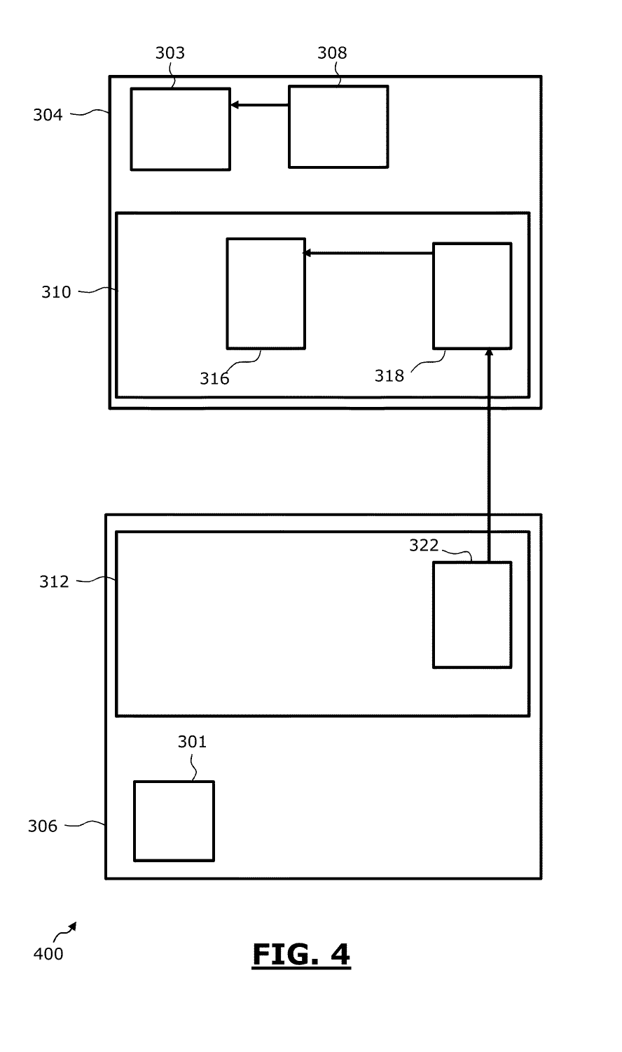

In a second embodiment shown in FIG. 4, the slave module 310 within a system 400 is incorporated in the slave appliance 304, and the master module 312 is incorporated in the master appliance 306 which contains commands 301.

In this embodiment, the slave module 310 does not comprise any module for communicating with the slave appliance 304 as it is incorporated in the slave appliance 304 and the master module 312 does not comprise any module for communicating with the master appliance 306 as it is incorporated in the master appliance 306.

In this embodiment, each module of the device according to the invention can be a software module or an electronic module using computational means such as a computer or a processor, already present on the slave appliance or the master appliance.

Moreover, the modules for sending and receiving data, on their own, can be modules existing within the slave appliance or the master appliance and which are arranged to carry out the desired operations.

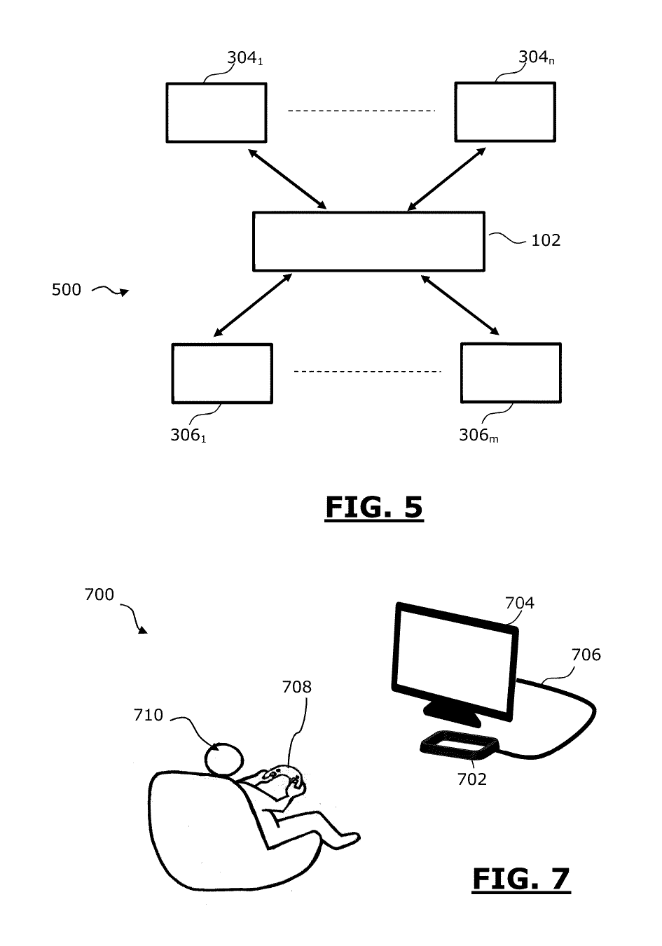

In another embodiment of a system 500 shown in FIG. 5, a control device 302 is used for controlling one or more slave appliances 304₁-304ₙ by one or more master appliances 306₁-306ₘ, with n and m being non-zero positive integers.

It is evident that the control device 302 can comprise several slave modules 310₁-310ₙ respectively allocated to the slave appliances 304₁-304ₙ. Moreover, or in combination with the preceding information in this paragraph, the control device 302 can also comprise several master modules 312₁-312ₘ respectively allocated to the master appliances 306₁-306ₘ.

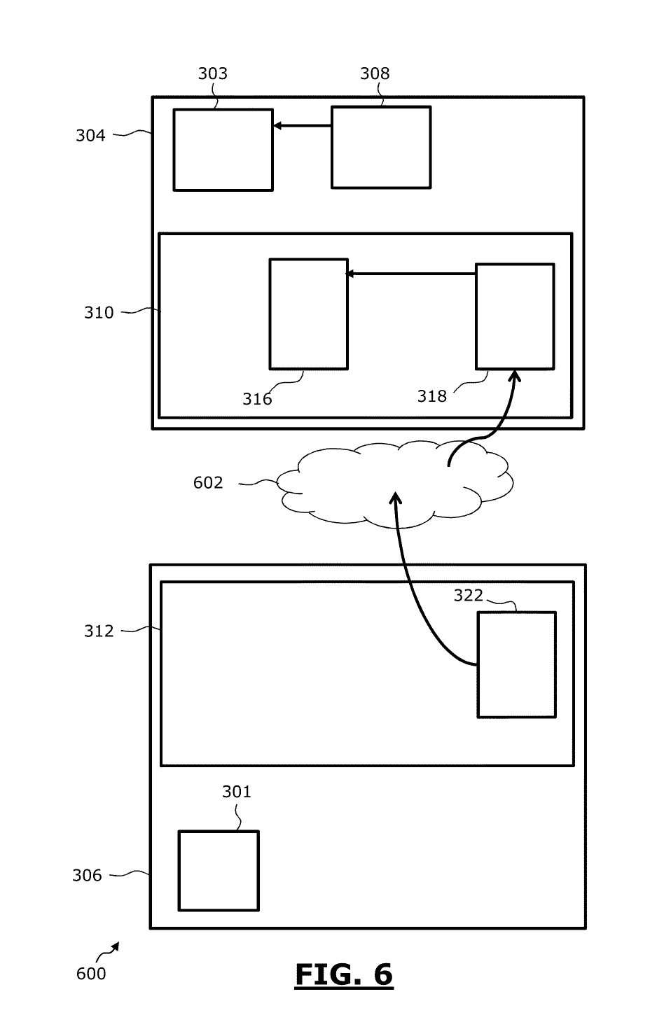

In a fourth preferred embodiment shown in FIG. 6, the system 600 is constituted by the same elements as the system 400 shown in FIG. 4, but differs therefrom by the fact that a communications network 602 is used for transmitting, i.e. receiving and sending, data originating from one of the appliances to the other.

This computer network is a wireless network. It can contain one or more wireless routers.

The communications network can be at least partially wired and contain one or more wired routers. It can also be a mixture of wireless and wired routers.

In a preferred embodiment, the communications network is a local network, such as a home network or a company network.

Of course, the computer network 602 can also be introduced and used in all the embodiments of a system according to the invention previously described.

In the configuration 700 shown in FIG. 7, the slave appliance is a tablet 702 connected to a television 704 by an HDMI cable 706 and the master appliance is a control pad 708.

The tablet 702 is a touch-screen tablet using the Android application platform having an HDMI output connection allowing it to be connected to a television. An example of a tablet of this type is an ARCHOS 10.1 ‘internet tablet’. This tablet contains a touch screen of 10.1″ i.e. 26 centimetres, with a resolution of 1024×600 pixels. The tablet can use another application platform supporting a touch user interface paradigm.

A user 710 watches the content displayed on the television from a certain distance, typically 2 to 4 metres, which is the typical distance at which a television viewer sits. The user holds the control pad 708 between his hands.

The tablet 702, connected to the television 704, has an interface for communicating wirelessly for example according to one of the Wifi (IEEE 802.11) or Bluetooth (802.15.1-3) standards. The control pad 708 in the user's hands has a wireless communication interface which can communicate according to the same standard as that of the tablet 702.

Moreover, the use of the Android platform allows the user to install on the slave appliance a large number of applications developed by an active developer community. These applications are designed to use the particular user interface paradigm.

When the user is at a distance from the tablet 702, he cannot interact with the applications according to the envisaged paradigm, i.e. according to the user interface paradigm supported by various sensors, principally the touch screen, but also accelerometers, gyroscopes and compasses. The invention allows this interaction via the appliance 708 for certain functions described in FIGS. 1A, 1B or also for certain games, the interface of which is according to the description of FIG. 2B.

The appliance 708 is in the user's hands. It will be capable of use to a certain extent as a control pad or for controlling other more general functions for the tablet 702.

In the configuration 700 shown in FIG. 7, the control device consists of slave software run by the tablet 702 which is the slave appliance. The slave software is run as a background task.

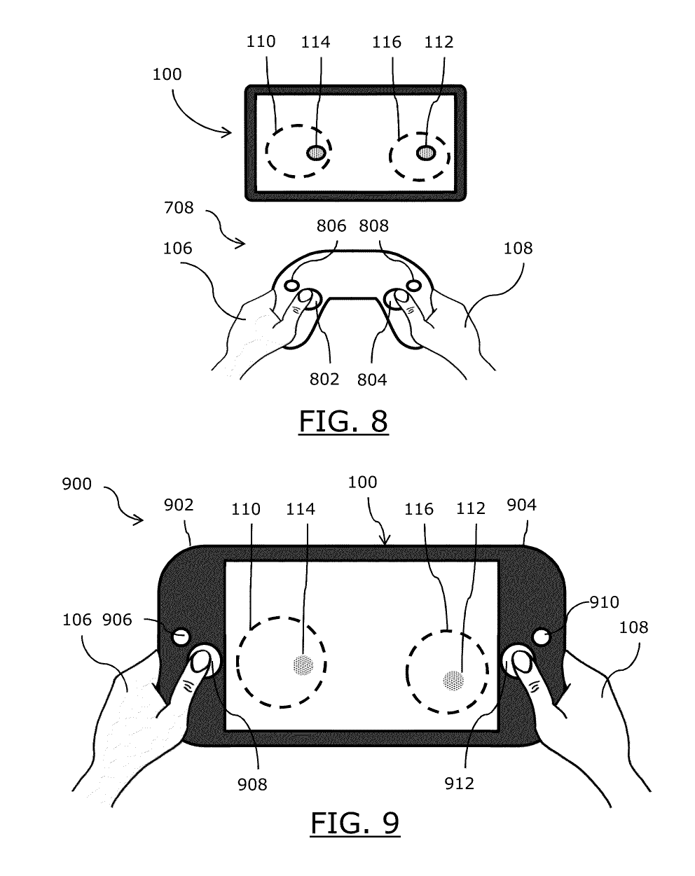

With reference to FIG. 8 which shows an appliance 708 according to the invention held in the hands, this appliance 708 comprises two joysticks 802, 804, and two push buttons 806, 808. The joysticks are control sticks. The appliance 708 is held by a user having two hands 106 and 108 resting thereon instead of resting them on the slave device 100. As previously stated, a large number of applications, in particular for games, require the user to use one or both hands on one or two surfaces of the touch screen determined by the application or the game. The appliance 708 according to the invention makes it possible to control the slave device 100 using the four commands 802, 804, 806 and 806.

Two surfaces 110 and 112 usually used in a game are also shown in FIG. 8. The surface 110 is on the side of the hand 106 while the surface 112 is on the side of the hand 108. The applications or games thus define the working surfaces accessible via the user's fingers positioned at the level of the locations 114 and 116 in the figure. The surfaces 110 and 112 are adapted to the possible movements of the fingers on the touch screen and are elliptical in shape.

In order to be able to use the appliance 708, the following method is proposed:
access is gained for parametering the control pad for the game via a specific action carried out by the user on the control pad (long simultaneous pressing of the two push buttons 806 and 808), and a graphical representation of the command action surfaces is shown on the screen,
the centre of the active touch area emulated by the first joystick 802 is then defined and when this centre is positioned, the user presses the button 806. Next, he defines the diameter of the circular area, then he presses the button 806 again.
the user proceeds in the same way to define the area of action of the second joystick 808 which is shown on the screen of the device 100 in FIG. 8.

Of course, a method can be proposed for defining the translation of action into emulation of a touch event.

In particular, very simple methods can be proposed in order to be able to use the control pad 708 according to the usual uses of an interface with a touch screen shown in FIGS. 1A and 1B.

A method is now described for interpreting and emulating several touches (“multitouch”) on the slave appliance: the device according to the invention is implemented with the master appliance. The processing means are arranged for interpreting and emulating two touches to carry out different actions. These actions are an action of increasing or reducing the size of an image displayed on the screen. Of course, other touches can be emulated such as scrolling or rotation.

In an additional variant of this method, the processing means are arranged to emulate on the slave appliance at least three touches to carry out three-finger sweep actions.

Moreover, two active areas of the screen display two cursors, the positioning of which is linked to a position of the joystick.

The processing means are configured in order to allow the user to implement an interpretation and emulation of two touches by the appliance. These interpretations and emulations are implemented in three different ways:

In a first variant, the user actuates the two joysticks so as to place two cursors on the screen. Each of the cursors is controlled by a joystick. A press on a specific button on the joystick is interpreted and simulated by the processing means as a touch at the place where the cursor is positioned. Similarly with the other joystick. While the specific buttons are pressed, any movement of a joystick is interpreted and emulated as if the user effectively moved a finger controlling the joystick. The configuration means are configured to emulate a touch equivalent to these finger movements.

In a second variant, described only with respect to its differences with the first, one press on a specific button of the joystick (and not two) is sufficient for the means of command to interpret the movements of the joysticks to emulate two different touches.

In a third variant, described only with respect to its differences with the first or the second, the use of a single joystick and a single button is sufficient for the means of command to interpret the movement of the joystick to emulate two different touches. Once the button is pressed, a movement of a single joystick linked to the position of a cursor is emulated as a movement corresponding to a press for the cursor controlled by the joystick and a corresponding symmetrical movement for the other cursor. The symmetry is axial, along a predetermined axis which is the horizontal axis. Of course, other symmetries, such as a symmetry with respect to the horizontal axis or a central symmetry can be determined.

In another embodiment of an appliance 900 according to the invention shown in FIG. 9, this appliance comprises two side portions 902, 904, arranged on either side of the longitudinal direction of the touch interface 100. The side portion 902 comprises a push button 906 and a joystick 908. The side portion 904 comprises a push button 910 and a joystick 912. The joysticks are control handles. The appliance 900 also comprises a housing (not shown) situated between the two side portions 902 and 904 arranged to be filled by the device 100. Thus, the touch interface 100 and the appliance 900 appear to constitute a single appliance.

As shown in FIG. 9, the appliance 900 is held by a user having two hands 106 and 108 placed thereon instead of placing them on the device 100, also shown in the figure. Two surfaces 110 and 112 usually used in a game are also shown in the figure. The surface 110 is on the side of the hand 106 while the surface 112 is on the side of the hand 108.

In a variant of an embodiment of the preceding appliance, the appliance 900 constitutes in reality a single appliance. The master and slave appliances are then parts of the appliance 900. In particular, the master appliance comprises the parts 902 and 904; the slave appliance comprises the device 100.

In a different implementation, the slave appliance can be an interactive television or equally an appliance without a screen connected to a TV. An example of such an appliance is a set-top-box or a TV Cam. In this implementation, the slave appliance uses the Android application platform, or generally another application platform supporting a touch user interface paradigm.

In combination or not with the different previously described modes and implementations, the processing means are configured to cause a command image to appear on a screen provided for displaying images generated by the slave appliance, containing one or more active areas corresponding to one or more commands emulated by the processing means. The active area(s) are displayed superimposed or transparently on images being displayed on the screen connected to the slave appliance.

Of course, the invention is not limited to the examples which have just been described and numerous adjustments can be made to these examples without exceeding the scope of the invention.

1. A device for controlling at least one so-called slave appliance provided to be controlled by touch, by at least one so-called master appliance comprising means of command, in particular a control pad, said device comprising:
means for transmitting at least one command sent by action on said means of command from said at least one master appliance to said at least one slave appliance and
processing means provided for interpreting said at least one command thus transmitted and emulating a touch on the slave appliance corresponding to said at least one command.

2. The device according to claim 1, characterized in that the processing means are moreover provided for generating an image of a touch interface on a screen connected to the slave appliance, so that an order emulated on said slave appliance activates a determined area of said screen.

3. The device according to claim 1, characterized in that it comprises moreover storage means for recording a configuration of the processing means.

4. The device according to claim 3, characterized in that the storage means are situated in an Internet computer device.

5. The device according to claim 1, characterized in that it comprises moreover means for loading a configuration in order to configure the processing means.

6. The device according to claim 1, characterized in that the transmission means comprise wireless transmission and reception means.

7. The device according to claim 1, characterized in that it comprises moreover pairing means securing a connection of said at least one master appliance and said at least one slave appliance.

8. The device according to claim 1, implemented with a master appliance in which the means of command comprise a joystick.

9. The device according to claim 8, characterized in that the means of command comprise a button and in that the joystick and said button cooperate with the processing means so that an action on said joystick causes a movement in the determined area of a pointer emulated on the slave appliance and in that an action on said button corresponds to a touch.

10. The device according to claim 8, implemented with a master appliance comprising two joysticks, characterized in that the processing means are arranged for interpreting and emulating several touches (“multitouch”) on the slave appliance.

11. The device according to claim 10, characterized in that the processing means are arranged to emulate on the slave appliance two touches in order to carry out an action of increasing or reducing the size of an image displayed on said screen.

12. The device according to claim 1, characterized in that the processing means are configured to cause a command image to appear on a screen provided for displaying images generated by the slave appliance, containing one or more active areas corresponding to one or more commands emulated by said processing means.

13. The device according to claim 12, characterized in that the active area(s) are displayed superimposed or transparently over images being displayed on the screen connected to the slave appliance.

14. The device according to claim 12, characterized in that an active area of the screen displays a cursor, the positioning of which is linked to a position of the joystick.

15. A method for controlling at least one so-called slave appliance provided to be controlled by touch, by at least one so-called master appliance comprising means of command, in particular a control pad, said method comprising the following steps:
transmission of at least one command sent by action on said means of command from said at least one master appliance to said at least one slave appliance; and
interpretation of said at least one command thus transmitted and emulation of a touch on the slave appliance corresponding to said at least one command.

16. The method according to claim 16, characterized in that the interpretation of the command thus transmitted emulates several touches (“multitouch”) on the slave appliance.

17. An appliance, in particular a control pad, comprising means for generating commands, characterized in that it implements the method according to claim 15 for controlling a so-called slave appliance controlled by touch.

18. The appliance according to claim 17, characterized in that it comprises moreover a housing for receiving the slave appliance.

19. A system comprising:
at least one so-called slave appliance, controlled by touch;
at least one so-called master appliance, comprising means of command; and
at least one device according to claim 1, provided for controlling said at least one slave appliance by said at least one master appliance.

20. The system according to claim 19, characterized in that means for receiving the command and the processing means of the at least one command device are incorporated in the at least one slave appliance.

21. The system according to claim 19, characterized in that the at least one slave appliance comprises means for running an operating system for a tablet computer, so that the master appliance controls a touch operating system.

22. The system according to claim 21, characterized in that the at least one slave device comprises moreover a screen for displaying a touch user interface.

23. The system according to claim 21, characterized in that the at least one slave device comprises a tablet computer, a mobile phone, an interactive television or a set-top box.

24. The system according to claim 21, characterized in that the master and slave appliances are incorporated in a single appliance.
